(19) United States
(12) Patent Application Publication
(10) Pub. No.: US 2014/0065517 A1
(43) Pub. Date: Mar. 6, 2014

(54) GAS DIFFUSION ELECTRODES FOR METAL-OXYGEN CELLS AND THEIR PRODUCTION

(71) Applicant: BASF SE, Ludwigshafen (DE)

(72) Inventors: Alexander Panchenko, Ludwigshafen (DE); Sigmar Braeuninger, Hemsbach (DE); Arnd Garsuch, Ludwigshafen (DE); Ruediger Schmidt, Ludwigshafen (DE)

(73) Assignee: BASF SE, Ludwigshafen (DE)

(21) Appl. No.: 14/012,031

(22) Filed: Aug. 28, 2013

Related U.S. Application Data
(60) Provisional application No. 61/697,333, filed on Sep. 6, 2012.
(60) Provisional application No. 61/737,884, filed on Dec. 17, 2012.

(51) Int. Cl. H01M 4/86

(52) U.S. Cl. CPC H01M 4/8605
USPC 429/523; 429/535

(57) ABSTRACT

The invention relates to gas diffusion electrodes for rechargeable electrochemical metal-oxygen cells, which comprise at least one porous support and one or more layers which are applied to one side of the porous support and comprise at least one catalyst for a metal-oxygen cell, wherein at least one function-relevant parameter changes continuously or discontinuously with increasing distance from the porous support in the catalyst-comprising layer or layers.

The present invention further relates to processes for producing such gas diffusion electrodes and rechargeable electrochemical metal-oxygen cells comprising such gas diffusion electrodes.

The invention relates to gas diffusion electrodes for rechargeable electrochemical metal-oxygen cells, which comprise at least one porous support and one or more layers which are applied to one side of the porous support and comprise at least one catalyst for a metal-oxygen cell, wherein at least one function-relevant parameter changes continuously or discontinuously with increasing distance from the porous support in the catalyst-comprising layer or layers.

The present invention further relates to processes for producing such gas diffusion electrodes and rechargeable electrochemical metal-oxygen cells comprising such gas diffusion electrodes.

Metal-air batteries are already known. These comprise, as essential constituents, a negative electrode composed of, for example, aluminum, lithium, magnesium, cadmium, mercury, lead, iron or preferably zinc and a positive electrode which preferably consists of an electronically conductive support material composed of finely divided carbon to which a catalyst for oxygen reduction is applied. Here, negative electrode and positive electrode are separated by a separator which can be in the form of a membrane. In a widespread embodiment, metal, for example zinc, is oxidized by means of atmospheric oxygen in an alkaline electrolyte to form an oxide or hydroxide. The energy liberated here is utilized electrochemically. Commercially available metal-air batteries are at present not rechargeable. However, intensive research is being carried out on rechargeable electrochemical metal-oxygen cells in which the metal ions formed during discharge are reduced back to the metal by application of an electric potential and oxygen is liberated by oxidation of the oxides or hydroxides formed during discharge. Rechargeable electrochemical metal-oxygen cells can, depending on the metal used, be operated both with aqueous acidic electrolytes (WO2012/012558) or aqueous basic or virtually water-free electrolytes (WO2011/161595).

To produce the electrochemical cells, negative electrode, membrane and positive electrode are generally produced separately and then pressed onto one another and introduced into an enveloping container.

Metal-oxygen cells usually comprise gas diffusion electrodes. Forming gas diffusion electrodes from an electronically conductive, porous support material, for example finely divided carbon, which is coated with catalyst for catalyzing the reduction of oxygen and oxygen evolution is known. It is also known that the gas diffusion electrode can be provided with pores which during operation are covered with an electrolyte film which represents an enlarged reaction area for the catalyzed reaction in the three-phase gas/liquid/solid system. The size of the pores and the hydrophobicity or hydrophilicity of the materials used are of great importance for optimal operation in order to prevent, for example, the electrolyte from filling the pores completely since this can, for example, hinder the passage of reaction gases such as oxygen.

WO 2007/065899 A1 has disclosed bifunctional air electrodes for secondary metal-air batteries in which the active layer of the electrode comprises an oxygen reduction catalyst and La₂O₃, Ag₂O and spinels as bifunctional catalyst. WO 2005/004260 A1 discloses a process for producing a gas diffusion electrode suitable for metal-air batteries, in which an active layer and a gas diffusion layer are combined to produce the gas diffusion electrode.

It is known from US 2002/064593 A1 that a membrane-electrode assembly for fuel cells can be produced by providing a membrane with a catalyst firstly on the one side and then on the other side, with one side in each case being supported by an underlay. U.S. Pat. No. 5,861,222 A discloses gas diffusion electrodes for fuel cells, which electrodes consist essentially of a proton-conducting membrane coated with a proton-conducting polymer having a defined porosity. US 2003/118890 A1 discloses membrane-electrode assemblies for fuel cells, in which the catalyst layer of the positive electrode and/or the negative electrode has at least two sublayers of which at least one is located directly on the membrane surface. US 2004/124091 A1 discloses a process for coating electrolyte membranes for fuel cells, in which the front side of the membrane is firstly coated with a catalyst while the rear side rests on a supporting film, and the rear side is subsequently coated. US 2004/023105 A1 discloses a process for applying a catalyst ink to a substrate for fuel cells at controlled humidity and temperature. US 2007/077350 A1 discloses the production of electrolyte membranes for fuel cells, where the membrane is supported by a film during a coating step. CA 2,511,920 A1 discloses gas diffusion layers for fuel cells, which layers consist of a porous substrate and catalyst particles distributed uniformly thereon.

The gas diffusion electrodes used hitherto in the known metal-air batteries do not satisfy the more demanding requirements, in particular in respect of simple adaptation of the electrode properties, especially for large-volume production.

The invention relates to a gas diffusion electrode for rechargeable electrochemical metal-oxygen cells, which comprises at least one porous support and one or more layers which are applied to one side of the porous support and comprise at least one catalyst for a metal-oxygen cell, wherein at least one function-relevant parameter changes continuously or discontinuously with increasing distance from the porous support in the catalyst-comprising layer or layers.

The porous support of the gas diffusion electrode of the invention has the function of allowing access of oxygen, for example in the form of atmospheric oxygen, to the catalyst-comprising layer or layers applied to one side of the preferably sheet-like porous support, without application of superatmospheric pressure.

For the purposes of the present invention, the expression “sheet-like” means that the porous support described, a three-dimensional body, is smaller in one of its three dimensions (extensions) in space, namely the thickness, than in respect of the other two dimensions, the length and the width. The thickness of the porous support is usually smaller than the second-largest dimension by a factor of at least 5, preferably by a factor of at least 10, particularly preferably by a factor of at least 20.

Possible embodiments of the porous support are described in more detail in WO 2011/1615978, page 4, lines 4 to 40, in which the porous support is referred to as solid medium or medium (A).

In a preferred embodiment of the present invention, a nonwoven or fiber braid, in particular a carbon fiber nonwoven, preferably having a weight per unit area of from 30 to 250 g/m², in particular from 50 to 150 g/m², is used as porous support for the gas diffusion electrodes of the invention. To increase the surface area and effect hydrophobicization, the nonwoven can be impregnated with, in particular, carbon black or polymers such as polytetrafluoroethylene in order to obtain a homogeneous porous and mechanically stable shape, as described, for example, in DE 195 44 323 A1. In a preferred embodiment, carbon or graphite powder and binder are pressed onto a power outlet lead, e.g. metal meshes or metal foams.

A porous support is usually used in the gas diffusion electrode of the invention. However, it is also possible to combine two or more layers of various sheet-like porous supports with one another, for example two carbon nonwovens having a different degree of graphitization or a carbon nonwoven with a metal mesh composed of tantalum.

The porous support in the gas diffusion electrode of the invention bears one or more layers comprising at least one catalyst for a metal-oxygen cell on one side. Preference is given to no coating which could hinder the access of oxygen being applied to the other side of the porous support since the oxygen is preferably supplied through this second side of the porous support during discharge and removed during charging.

The layer or layers applied to the porous support comprise at least one catalyst for a metal-oxygen cell. These catalysts are known in principle and serve particularly, as described at the outset, to catalyze the oxygen reduction reaction, hereinafter also referred to as discharging catalyst, or to catalyze the oxygen evolution reaction during charging in a metal-oxygen cell, hereinafter also referred to as charging catalyst.

Suitable catalysts are, in particular, mixed oxides, for example cobalt oxides, nickel oxides, iron oxides, chromium oxides, tungsten oxides and noble metals, in particular silver. In a preferred embodiment, a catalyst combination of a catalyst which catalyzes the reduction of oxygen and a bifunctional catalyst as described in WO 2007/065899 A1, page 7, line 14 to page 8, line 27, is used. A preferred catalyst which catalyzes both the oxidation and reduction of oxygen is La₂O₃. Preferred catalysts for the reduction of oxygen are MnO₂, KMnO₄, MnSO₄, SnO₂, Fe₂O₃, Co₃O₄, Co, CoO, Fe, Pt, Pd, Ag₂O, Ag, spinels and perovskites.

In a preferred embodiment of the gas diffusion electrode of the invention, the catalyst-comprising layer or layers comprise(s) at least one charging catalyst which catalyzes charging and at least one discharging catalyst which catalyzes discharge.

Apart from at least one catalyst for a metal-oxygen cell, the layer or layers applied to the porous support preferably comprise at least one binder which is usually an organic polymer, as described in more detail in WO 2011/161598, page 6, line 28 to page 8, line 15, where the binder is referred to as polymer (C) or binder (C).

In the catalyst-comprising layer or layers of the gas diffusion electrode of the invention, at least one function-relevant parameter changes continuously or discontinuously with increasing distance from the porous support.

For the purposes of the present invention, a function-relevant parameter is a parameter which significantly influences the operation of the gas diffusion electrode, in particular the function of the catalyst-comprising layer or layers, especially the stability, first and foremost the stability in the repetition of many charging and discharging cycles, the capacity and the current density. The function-relevant parameter is preferably the porosity, the hydrophobicity, the corrosion stability and/or the catalyst composition, in particular the chemical composition, the quantitative composition and/or the morphology of the constituents used for the catalyst-comprising layer.

In a preferred embodiment of the gas diffusion electrode of the invention, the function-relevant parameter is the porosity, the hydrophobicity, the corrosion stability and/or the chemical composition of the catalyst.

The porosity is defined as the percentage of the hollow space volume in the total volume of the electrode layer. The porosity is determined by means of mercury porosimetry.

For the purposes of the present invention, the hydrophobicity is determined via the proportion of a known hydrophobic component, for example a polyolefin or a fluorine-comprising polymer, for example polytetrafluoroethylene, in the catalyst-comprising layer or layers. The component by means of which the hydrophobicity can be set can also perform the function of a binder. In principle, the hydrophobicity of a layer can also be determined by means of the known contact angle method.

For the purposes of the present invention, the corrosion stability is determined by the extent of the reaction of a component of a catalyst-comprising layer with oxygen, for example, by the formation of carbon dioxide being determined in the case of elemental carbon as layer component.

The chemical composition of the catalyst in a catalyst-comprising layer can be determined by means of elemental analysis and from the composition of the catalysts used.

In a further preferred embodiment of the gas diffusion electrode of the invention, one or more catalyst-comprising layers which in themselves are uniform in respect of the function-relevant parameters and differ from one another in at least one of the function-relevant parameters have been applied to the porous support.

The catalytic activity of various catalyst-comprising layers can preferably be set by using different amounts of the catalyst or different catalysts or modifications thereof in the individual layers.

In a further preferred embodiment of the gas diffusion electrode of the invention, the concentration of the charging catalyst in the catalyst-comprising layer or layers decreases with increasing distance from the porous support and the concentration of the discharging catalyst in the catalyst-comprising layer or layers increases with increasing distance from the porous support.

The porosity in various catalyst-comprising layers can preferably be set by adding a particular amount of one or more pore formers to the composition by means of which the respective catalyst-comprising layer is produced, with the pore former being removed again later after formation of the layer so as to form a pore.

In a further preferred embodiment of the gas diffusion electrode of the invention, the catalyst-comprising layer or layers have a lower porosity with increasing distance from the porous support.

The hydrophobicity of the individual catalyst-comprising layers or within a catalyst-comprising layer is preferably controlled by use of suitable substances, in particular by addition of Teflon, in particular in the form of a powder. In a preferred embodiment, 60% by weight of Teflon are added to the layer which was applied directly to the porous support and 10% by weight of Teflon are added to the layer farthest removed from the porous support, in each case based on the solids content.

In a further preferred embodiment of the gas diffusion electrode of the invention, the catalyst-comprising layer or layers have a lower hydrophobicity with increasing distance from the porous support.

The corrosion stability of various catalyst-comprising layers can, for example, be set by using various catalyst support carbons which differ in their surface area and corrosion stability in the catalyst-comprising layers in such a way that the side of the first catalyst-comprising layer facing the porous support is coated with the most corrosion-stable carbon material. The degree of graphitization of the carbon particles which serve as catalyst support decreases with increasing distance from the porous support and the surface area of the carbon particles increases with increasing distance from the porous support.

In a further preferred embodiment of the gas diffusion electrode of the invention, the catalyst-comprising layer or layers have a higher corrosion stability with increasing proximity to the porous support.

The above-described gas diffusion electrode of the invention, which comprises at least one porous support and one or more layers applied to one side of the porous support, where each layer comprises at least one catalyst for a metal-oxygen cell, and in which at least one function-relevant parameter in the catalyst-comprising layer or layers changes continuously or discontinuously with increasing distance from the porous support can be produced in various ways.

Possible parameters by means of which the setting of function-relevant parameters can be carried out have been indicated above.

The continuous or discontinuous change in a function-relevant parameter is preferably achieved by application of a plurality of catalyst-comprising layers having different compositions or by application of at least one layer which itself has a gradient on one side of the porous support. An individual layer can accordingly be homogeneous, i.e. intrinsically uniform, in respect of the function-relevant parameters, and the next layer then differs in at least one function-relevant parameter from the first layer.

The present invention further provides a process for producing a gas diffusion electrode, in particular a gas diffusion electrode according to the invention as described above, namely a gas diffusion electrode for rechargeable electrochemical metal-oxygen cells, which comprise at least one porous support and one or more layers which are applied to one side of the porous support and comprise at least one catalyst for a metal-oxygen cell, wherein at least one function-relevant parameter changes continuously or discontinuously with increasing distance from the porous support in the catalyst-comprising layer or layers, in which process in each case one catalyst-comprising composition is applied in one or more steps by screen printing, spraying or doctor blade coating in order to produce in each case a catalyst-comprising layer on the porous support of the gas diffusion electrode.

The description and preferred embodiments of the porous support, the catalyst-comprising layers, the catalyst for a metal-oxygen cell and the function-relevant parameters for the process of the invention correspond to the abovementioned description of these components and features for the gas diffusion electrode of the invention.

To produce a catalyst-comprising layer on the porous support of the gas diffusion electrode, a catalyst-comprising composition is applied in each case. The catalyst-comprising composition comprises not only the constituents which later form the catalyst-comprising layer and remain there, for example catalysts, binders such as Teflon and catalyst supports such as carbon particles, but also constituents which are removed again in the formation of the layer, for example liquids such as water or pore formers. The removable constituents of the catalyst-comprising composition serve, in particular, to set a desired consistency of this composition so as to be able to apply the composition as layer to the porous support by means of a particular method. A fluid catalyst-comprising composition is, for example, referred to as an ink and can be sprayed, while a viscous composition can be applied by means of a doctor blade.

The methods of applying the catalyst-comprising composition, e.g. screen printing, spraying or doctor blade coating, are known to those skilled in the art.

In preferred screen printing processes, the catalyst-comprising composition is applied by means of a doctor blade via a screen. The amount applied is determined by the theoretical volume (mesh opening, fiber thickness) of the screen, the process parameters and the rheological properties of the catalyst-comprising composition in the form of a paste.

The production process of the invention makes it possible to achieve a continuous change in electrode properties in respect of porosity, hydrophobicity, corrosion stability or catalyst composition in the layer thickness and/or in a dimension perpendicular to the layer thickness of the sheet-like electrode, which is of particular importance for batteries operated vertically. This is achieved, for example, by application of one or more layers on top of one another, with a maximum of 10 layers preferably being applied. However, it is also possible to achieve a concentration gradient within a layer. This is possible according to the invention by, for example, sedimentation or controlled decomposition of a pore former.

In a preferred embodiment of the process of the invention, from 2 to 10 catalyst-comprising layers are applied to the porous support.

In a further embodiment of the process of the invention, a plurality of catalyst-comprising layers which are in themselves uniform in respect of the function-relevant parameters but differ from one another in at least one of these parameters are applied.

The process of the invention makes it possible to obtain gas diffusion electrodes having a porosity, pore structure and pore distribution which can be set in a targeted manner. The process is particularly well suited to variation and matching of the pore properties of the gas diffusion electrode.

To set the porosity, pore structure and pore distribution in a targeted manner in a catalyst-comprising layer, at least one pore former which can be decomposed, in particular thermally decomposed, or leached out is added to the catalyst-comprising composition which is applied to the porous support.

In a further preferred embodiment of the process of the invention, one or more pore formers which can be decomposed or leached out are comprised in the catalyst-comprising composition for producing the catalyst-comprising layer.

The porosity of the various catalyst-comprising layers can preferably be set by adding a particular amount of one or more pore formers to the composition by means of which the respective catalyst-comprising layer is produced, with the pore former being removed again later after formation of the layer so as to form a pore.

Preferred pore formers are decomposable organic or inorganic compounds, for example carbonates, in particular ammonium, potassium or sodium carbonate, or hydrogencarbonates, in particular sodium hydrogencarbonate, low molecular weight organic compounds, for example ammonium formate, salts of organic acids, in particular oxalates, or organic polymers such as polyvinyl alcohol.

The desired porosity is set by appropriate treatment with these pore formers. A porosity of from 30 to 80% is preferably set in this way. The inorganic substances are preferably decomposed by treatment with an acid or alkali or water and/or leached out. The organic substances are preferably decomposed by means of a suitable thermal treatment, in particular at temperatures of from 50 to 400° C., in particular from 200 to 370° C., or leached out by means of solvents.

In a further preferred embodiment of the process of the invention, ammonium carbonate, potassium carbonate and/or sodium carbonate are used as pore formers.

A particularly preferred process comprises the following steps:
1. Provision of a porous support, preferably an electrically conductive nonwoven, in particular a carbon fiber nonwoven.
2. Production of a dispersion or solution of a catalyst-comprising composition as coating composition.
3. Application of the coating composition in dispersion or solution by screen printing, spraying or doctor blade coating.
4. Drying of the applied coating composition, in particular by heating.
5. Calendering, pressing and compaction.
6. Application of at least one further coating composition whose composition differs from the composition used in step 3.
7. Optionally application of further layers, in particular a Teflon layer, to the rear side in order to improve further properties, e.g. avoidance of loss of electrolyte.
8. Heat treatment.

The gas diffusion electrode of the invention can be used in a rechargeable electrochemical metal-oxygen cell. Here, the catalyst-comprising layers of the electrode have to have the required gas permeability and sufficient ion conductivity. Furthermore, a negative electrode comprising aluminum, lithium, sodium, magnesium, cadmium, mercury, lead, iron or preferably zinc is used in such a metal-oxygen cell.

The present invention further provides a process for producing a rechargeable electrochemical metal-oxygen cell, in particular a zinc-oxygen cell, comprising a gas diffusion electrode and a negative electrode, wherein a gas diffusion electrode according to the invention, as described above, is used as gas diffusion electrode.

The present invention likewise provides rechargeable electrochemical metal-oxygen cells, in particular zinc-oxygen cells, comprising a negative electrode and a gas diffusion electrode according to the invention as described above.

As negative electrode for the rechargeable electrochemical metal-oxygen cell of the invention, it is possible to use the customary metals, preferably iron, aluminum, magnesium, lithium, sodium, cadmium, mercury, lead and in particular zinc. The metal can be present as a solid plate, as a sintered, porous electrode, as metal powder or granular material, optionally sintered. In a preferred embodiment, the metal, in particular zinc, is used as powder in a particle size of preferably from 2 to 500 μm. In a further preferred embodiment, the powder is admixed with a binder to improve the dimensional stability. Suitable binders can be organic or inorganic in nature, with preference being given to, in particular, polytetrafluoroethylene (PTFE) and polyvinylidene fluoride.

In a preferred embodiment, the metal powder, in particular the zinc powder, is used in the form of a paste with an organic binder, in particular using polytetrafluoroethylene (PTFE) and/or polyvinylidene fluoride as binder.

The rechargeable electrochemical metal-oxygen cell of the invention further comprises a membrane, which is also referred to as separator, for separating negative electrode and positive electrode.

As separator, preference is given to using an acid- or alkali-resistant, inert material. In a preferred embodiment, polyolefins are used. The separator preferably has a layer thickness of from 10 to 200 μm. Preferred polyolefins are polyethylene and polypropylene. In addition, other acid- or alkali-resistant polymers known to those skilled in the art or inorganic compounds are suitable as separator.

In a preferred embodiment, the separator has a porosity of from 30 to 80%, in particular from 40 to 70%. Here, the porosity is the ratio of void volume to total volume.

The combination of at least two electrodes, the metal electrode and the gas diffusion electrode, an electrolyte and a separator is referred to as membrane-electrode assembly (MEA). The individual membrane-electrode assemblies can be connected to one another, preferably in series. For this purpose, the individual assemblies can be fixed between bipolar plates which separate the individual cells from one another in a gastight manner and may perform the task of supplying gas and conducting away the current.

The electrolyte used for the rechargeable electrochemical metal-oxygen cells of the invention is liquid in a preferred embodiment. Acids and alkalis, in particular, are used as electrolytes. In the case of lithium- or sodium-comprising negative electrodes, electrolytes used are, in particular, the electrolytes comprising nonaqueous organic solvents which are described in WO 2011/148357, page 9, line 1 to page 10, line 29, and further comprise a corresponding salt.

In another preferred embodiment, the electrolyte can also be used in gel form.

The constituents of the rechargeable electrochemical metal-oxygen cells can be present in various arrangements (stacks). Preferred stacks have the following arrangement:
Arrangement 1: bipolar plate/negative electrode/separator/gas diffusion electrode/bipolar plate
Arrangement 2: bipolar plate/positive electrode/separator/negative electrode/separator/positive electrode/bipolar plate
Arrangement 3: bipolar plate/negative electrode/separator/positive electrode/separator/negative electrode/bipolar plate

In a preferred embodiment, the separator is coated on one side with the material for forming the negative electrode, in particular metal powder, and then joined to the gas diffusion electrode to be used according to the invention on the other side. In a further preferred embodiment, the separator, for example in solution or dispersion, is applied to the negative electrode or the gas diffusion electrode and the electrodes are then joined.

Positive electrode and negative electrode are joined by means of electric connections. These electric connections are preferably produced by introducing electrode layers composed of conductive and corrosion-resistant materials, preferably carbon or nickel, in a manner known per se and joining these to the corresponding electrodes. Further suitable compounds are Cu alloys known to those skilled in the art, electrically conductive polymers such as polyaniline or polyacetylene. In a particularly preferred embodiment, a composite of carbon and polymer is used.

For use, the rechargeable electrochemical metal-oxygen cells produced according to the invention are installed in a suitable container. This container preferably comprises polymer. It is provided with insulated connections for the electrodes and has at least one opening through which air can enter for operation of the cell.

The present invention further provides for the use of rechargeable electrochemical metal-oxygen cells according to the invention in metal-oxygen batteries, in particular zinc-air batteries. The present invention further provides metal-oxygen batteries, in particular zinc-air batteries, comprising at least one rechargeable electrochemical metal-oxygen cell according to the invention. Rechargeable electrochemical metal-oxygen cells according to the invention can be combined with one another in metal-oxygen batteries according to the invention, for example connected in series or connected in parallel. Connection in series is preferred.

The present invention further provides for the use of rechargeable electrochemical metal-oxygen cells according to the invention, as described above, in automobiles, in two wheeled vehicles driven by an electric motor, aircraft, ships or in particular stationary energy stores.

The present invention is illustrated by the following examples, which do not, however, restrict the invention:

### EXAMPLES

The following starting materials were used:

TABLE 1

| | | Origin/brand/ |
|---|---|---|
| Name | Chemical composition | parameter |
| Discharging catalyst 1 | Ag/C-20% of Ag on carbon | BASF SE |
| | black | |
| Charging catalyst | Fe₂ (WO₄)₃, | BASF SE |
| | BET surface area: 3 m²/g | |
| Porous support | carbon nonwoven H2315 | Freudenberg |
| (gas diffusion material) | IX11 CX45 | |

### Example 1

General preliminary remark: For the purposes of the present invention, figures in percent are percent by weight, unless expressly indicated otherwise.

I. Production of a Formulation

I.1 Production of an Ink, Batch 1

In a stirred vessel, 2 g of ethoxylated trimethylnonyl alcohol and 66.7 g of water were mixed by means of a magnetic stirrer. 2.1 g of discharging catalyst Ag/C—20% of Ag on carbon black were then added while stirring. The mixture was subsequently dispersed by means of ultrasound, using the following procedure: 14 mm US ultrasonic probe, cycle 1, amplitude 45%, 8° C. cooling, magnetic stirrer 75% up to an energy input of 0.025 kWh. 3.4 g of an aqueous dispersion of polytetrafluoroethylene having a solids content of 60% were subsequently added and the mixture was stirred for 15 minutes without further ultrasound. The mixture was filtered through a 190 μm sieve to give an ink which will hereinafter also be referred to as ink 1.

I.2 Production of an Ink, Batch 2

In a stirred vessel, 2 g of ethoxylated trimethylnonyl alcohol and 20 g of water were mixed by means of a magnetic stirrer. 0.4 g of charging catalyst Fe₂(WO₄)₃, BET surface area of 3 m²/g, was then added while stirring. The mixture was subsequently dispersed by means of ultrasound, using the following procedure: 14 mm US ultrasonic probe, cycle 1, amplitude 45%, 8° C. cooling, magnetic stirrer 75% up to an energy input of 0.025 kWh. 1 g of an aqueous dispersion of polytetrafluoroethylene having a solids content of 60% were subsequently added and the mixture was stirred for 15 minutes without further ultrasound. The mixture was filtered through a 190 μm sieve to give an ink which will hereinafter also be referred to as ink 2.

II. Production of an Electrode According to the Invention by Application of Ink 1 and Ink 2

A carbon nonwoven H2315 IX11 CX45 from Freudenberg) was used as porous support. Ink 1 was subsequently sprayed at 75° C. under reduced pressure onto the porous support by means of a gun, with nitrogen being used for spraying. This gave an additional loading of 2 mg/cm², calculated for the sum of discharging catalyst and binder. The porous support was subsequently calendered by means of a calender, with the calender being set as follows:

Pressing-on pressure of 2 N/mm²

Advance speed of 0.5 m/min

Roller temperature of 100° C.

In the second coating step, the porous support coated with ink 1 was used. A layer of ink 2 was sprayed at 75° C. under reduced pressure onto the first coating by means of a gun, with nitrogen being used for spraying. This gave an additional loading of 2 mg/cm², calculated for the sum of charging catalyst and binder. The porous support was subsequently calendered by means of a calender, with the calender being set as follows:

Pressing-on pressure of 2 N/mm²

Advance speed of 0.5 m/min

Roller temperature of 100° C.

The carbon nonwoven which had been coated twice on one side was subsequently treated thermally in an oven, temperature: 320° C. At this temperature, the polytetrafluoroethylene softened.

This gave an electrode according to the invention having oxygen reduction and oxygen evolution catalysts in various layers of the gas diffusion electrode.

1. A gas diffusion electrode for a rechargeable electrochemical metal-oxygen cell, the gas diffusion electrode comprising:
a porous support and
a layer applied to one side of the porous support,
wherein the layer comprises a catalyst for a metal-oxygen cell, and a function-relevant parameter changes continuously or discontinuously with increasing distance from the porous support in the layer.

2. The gas diffusion electrode according to claim 1,
wherein the layer comprises a charging catalyst and a discharging catalyst.

3. The gas diffusion electrode according to claim 1,
wherein the function-relevant parameter comprises porosity, hydrophobicity, corrosion stability, chemical composition of the catalyst, or a combination thereof.

4. The gas diffusion electrode according to claim 1,
wherein the layer is uniform in respect of the function-relevant parameter,
the layer differs from one another in the function-relevant parameter, and
the layer has been applied to the porous support.

5. The gas diffusion electrode according to claim 2,
wherein a concentration of the charging catalyst in the layer decreases with increasing distance from the porous support and
a concentration of the discharging catalyst in the layer increases with increasing distance from the porous support.

6. The gas diffusion electrode according to claim 1,
wherein the layer has a lower porosity with increasing distance from the porous support.

7. The gas diffusion electrode according to claim 1,
wherein the layer has a lower hydrophobicity with increasing distance from the porous support.

8. The gas diffusion electrode according to claim 1,
wherein the layer has a higher corrosion stability with increasing proximity to the porous support.

9. A process for producing a gas diffusion electrode according to claim 1, the process comprises:
applying a catalyst-comprising composition by screen printing, spraying, doctor blade coating, or a combination thereof thereby producing a catalyst-comprising layer on the porous support of the gas diffusion electrode.

10. The process according to claim 9, further comprising:
applying 2 to 10 catalyst-comprising layers to the porous support.

11. The process according to claim 9, further comprising:
decomposing or leaching out a pore former,
wherein the catalyst-comprising composition comprises the pore former.

12. The process according to claim 11,
wherein the pore former comprises ammonium carbonate, potassium carbonate, or sodium carbonate.

13. A process for producing a rechargeable electrochemical metal-oxygen cell, the process comprising:
producing the rechargeable electrochemical metal-oxygen cell,
wherein the rechargeable electrochemical metal-oxygen cell comprises the gas diffusion electrode according to claim 1 and a negative electrode.

14. A rechargeable electrochemical metal-oxygen cell, comprising:
a negative electrode and
the gas diffusion electrode according to claim 1.
